(19) United States
(12) Patent Application Publication
(10) Pub. No.: US 2002/0106613 A1
(43) Pub. Date: Aug. 8, 2002

(54) Management accounting method and system considering time value and program recording medium therefore

(76) Inventor: Shinzaburou Takada, Kyoto-shi (JP)

Correspondence Address: MORRISON LAW FIRM, 145 North Fifth Avenue, Mt. Vernon, NY, 10550, US

(21) Appl. No.: 09/878,777

(22) Filed: Jun. 11, 2001

(30) Foreign Application Priority Data
Jun. 9, 2000 (JP) 2000-173746

(51) Int. Cl. G09B 9/00

(52) U.S. Cl. 434/1

(57) ABSTRACT

A management accounting method considers a time value for evaluating the result with the net earning adding a capital cost, by inputting the target ROE as a rate K_{E} of a stockholder's equity to determine a weighted average cost of capital WACC, by using the WACC as a discount rate to calculate a net present value NPV of a cash flow, and by developing the adopted will decision content into a profit/loss statement. While some conventional investment analyzing methods have analyzed and evaluated an investment at the unit of a project by comparing and investigating the project plan by the DCF method, none of them have been able to make the will decision of the investment by comparing the investment with the actual profit/loss calculations of an enterprise thereby to analyze whether or not the investment would achieve a target ROE set as a management target. Moreover, the time value by the DCF method cannot be realized by an accounting so that the will decision content adopted cannot be converted into the profit/loss calculations.

### BACKGROUND OF THE INVENTION

1. Field of the Invention

The accounting business is classified into financial accounting, for providing interested persons (e.g., stockholders or creditors) outside of an enterprise with economic information on the enterprise, and management accounting, for providing a manager or similar interested person inside the enterprise with economic information on the enterprise. The present invention relates to a management accounting method and system directed to management accounting, and a program recording medium therefor. More particularly, the invention relates to a management accounting method and system considering the time value, and a program recording medium therefor. The present invention is useful for making a will decision in association with the management target, linking calculations by a DCF method (Discounted Cash Flow) to be used in the will decision and accounting calculations, and analyzing the plan or result of the profit/loss calculations in each branch after the investment was executed, in association with a management target.

2. Related Art

Japan in its postwar rehabilitation has a national target to catch up with the advanced European and American nations and is in an era of low-risk and high-return, in which the risk is low in the selection of routes whereas the investment chances are high. On the enterprise side, therefore, there is neither necessity for investigating the effective use of investment nor is an internal structure therefor. On the other hand, the indirect financing is centered with much borrowing from banks so that a capital-adequacy ratio is extremely low. Therefore, the manager is not required to be conscious of the stockholders. In this era, it is a rational management target to maximize the current earnings covering the loan interest.

About fifteen years ago, around the time of the Plaza Accord of 1985, however, Japan seems to have caught up with the advanced nations. As a result of this catch-up, the management environments of Japan turned from the conventional low-risk/high-return to a high-risk/high-return, in which the selection of ways is highly risky. After the financing was shifted to the direct one by the capital liberalization at the second half of 1980, moreover, Japanese enterprises have been requested to cope with the fund excess era, i.e., to make an efficient fund working as the know-how to use the fund effectively.

The management function necessary in the fund excess era, i.e., in the high-risk/high-return era is said to make the fund working efficient and to continue the growth. The management target is said to improve the fund efficiency indices, such as ROE (Return On Equity), and to enlarge the cash flow. In the global standards, therefore, the ROE and the cash acquirability are the measures for evaluations. In the global accounting standards, the cash flow statement is positioned as one of financial statements together with a balance sheet (B/S) and a profit and loss statement (P/L). In the revised accounting standards of Japan, too, the cash flow statement has been regulated as a third financial statement.

Here, the ROE is a capital efficiency index indicating the “productivity of capital”, as translated into the “capital-adequency earning rate”, and is determined from the following Formula 10. The present enterprises of Japan have a productivity level at the production site in a worldwide top class but are considerably lower in the ROE than the global average, and it is accepted that the capital efficiency function is delayed.

$$ROE = \frac{Earnings ( Increase in Stockholder ' s Equity )}{Stockholder ' s Equity} = \begin{matrix}Earnings ← P / L \\ Input Cash ← B / S\end{matrix} \qquad Formula 10$$

The reason why the enterprises of Japan have a low ROE is related to the past route they have followed. Specifically, the enterprises of Japan in the low-risk/high-return era have been short of funds. It is, therefore, unnecessary to consider the stockholder's capital (B/S) of the denominator so much in the aforementioned Formula 10. But, the management could be made with a target of the maximization of the operating earnings by viewing only the earning (P/L) of the numerator.

In the company managements centering the profit/loss statement, a plan of the profit/loss statement is prepared as the management plan for each branch before the beginning of a financial year. The plan and the result are then compared at the monthly settlement of accounts. With a discrepancy therebetween, moreover, the cause is analyzed to take a countermeasure repeatedly for the next and later months.

The plan of the profit/loss statement, as prepared for each branch, is developed into the cost management and is combined with the quality control (QC) actions and the industrial engineering (IE) actions of the site so that the enterprises of Japan have taken effects. This is the “production technique for making goods of high qualities inexpensively”, which is the strong point of the enterprises of Japan. Thus, Japan has been enable to grow into the advanced country of first class by the management style of enhancing the economic effects by comparing the target profit/loss statement and the actual one and by eliminating the difference. However, the enterprises of Japan have been managed centering the profit/loss statement so that there has never been established the management structure which is conscious of the necessary minimum earning for the stockholders, i.e., the capital cost.

Here, the important point in the management of the high-risk/high-return era is that an investment for the future is to determine the frame of the management, and that the investment is the fund operating point. Here, the investment has a wide concept covering not only one for facilities but also all disbursements necessary not for the acquisition of earnings at present but for the future, such as ones for research and development, for information systems and for workers' educations.

The economic analysis of the investment is made not by the accounting calculations but by the cash flow analysis using the DCF method. This DCF method is a general name of the method for judging the economy by converting the cash flow, as predicted as the result of investment, into the present value at a discount ratio considering the economic value and risk of the time, as expressed by the following Formula 4.

In the projects of plan A and plan B enumerated in the following Table 1, for example, both the total sums of returns for four years are ¥4,000,000 so that which is larger cannot be found out by comparing the total sums of the returns.

In the DCF method, however, the sum of the returns of each year is evaluated by multiplying it by the cost factor which is determined by the following Formula 11. Here is added the economical value of time.

If the discount ratio adding the time and risk is 10% and if the time period t is four years, for example, the total sum of the present value of the Plan A is 17, as enumerated in the Table 1, whereas the total sum of the present value of the Plan B is -3 because its return timing is later than that of the Plan A. Therefore, it is an advantage of the DCF method that the plan A is judged superior to the plan B.

TABLE 1
Unit: ¥ 10,000

| | | 0th | 1st | 2nd | 3rd | 4th | Sum |
|---|---|---|---|---|---|---|---|
| Plan A | Return | | 100 | 100 | 100 | 100 | 400 |
| | Investment | −300 | | | | | −300 |
| | Cost Factor | 1.000 | 0.909 | 0.826 | 0.751 | 0.683 | |
| | Present Value | −300 | 91 | 83 | 75 | 68 | 17 |
| Plan B | Return | | 30 | 60 | 110 | 200 | 400 |
| | Investment | −300 | | | | | −300 |
| | Cost Factor | 1.000 | 0.909 | 0.826 | 0.751 | 0.683 | |
| | Present Value | −300 | 27 | 50 | 83 | 137 | −3 |

$$Cost Factor = \frac{1}{{( 1 + Discount Factor )}^{t}} \qquad Formula 11$$

In order to cope with the high-risk/high-return era, it is important how to match the risk on a time axis. It is, therefore, indispensable to establish a management structure for making the will decision by the cash flow analysis using the DCF method. The “cash flow stressing management”, as has been proposed in the recent years, is one in which the will decision is referred to the maximization of the present value of the free cash flow to be expected in the future. There have been proposed in the various fields an investment analyzing method supporting the will decision and an investment analyzing program for executing the analysis to be executed by a computer.

Some conventional investment analyzing methods and some programs for realizing the methods have analyzed and evaluated an investment at the unit of a project, but none of them have been able to make the will decision of the investment by comparing the investment with the actual profit/loss calculations of an enterprise, thereby analyzing whether or not the investment would achieve a target ROE set as a management target. In the conventional investment analyzing methods and the programs for realizing the methods, therefore, it has been possible to compare and investigate a plurality of the project plans by subjecting a plurality of project plans to the DCF calculations. However, it has been impossible to judge whether or not the project plan selected can achieve the target ROE set as the management target, and accordingly what the resultant financial statements will become.

In the sites of the enterprises of Japan, on the other hand, it has been done for a long period by using the profit/loss statement, to plan the budget and to analyze the result. Even if the will decision has been made by the DCF calculations, however, there arises a problem that the after-following management cannot be understood in the site unless indicated by the profit/loss statement.

Here, the conventional investment analyzing method and the program for realizing the method have failed to joint the calculations by the DCF method and the accounting calculations. There arises another problem that the will decision made by the DCF method cannot be after-followed so that the management target set by the top of an enterprise is not associated with the actions of the site.

The reasons why the DCF method and the accounting cannot be associated with each other are that the DCF method recognizes the economic value of time whereas the accounting does not recognize the economic value of time, that the DCF method investigates the economies of the individual investment projects for the entire period whereas an object of the accounting is to measure the earnings for a predetermined period, and that the DCF method recognizes the stockholder's capital cost whereas the accounting does not.

Because of these differences in the concepts and the calculating methods, the DCF method and the accounting have been thought as calculating structures of absolutely different characteristics and contrary to each other. However, it is needless to point out how important it is to after-follow the will decision. Without this following structure, it is not only impossible to retain the propriety of the will decision itself but also uncertain for an enterprise to establish a proper will decision structure.

### OBJECTS AND SUMMARY OF THE INVENTION

It is an object of the present invention to provide a management accounting method which overcomes the foregoing problems.

It is a further object of the present invention to introduce the time value into the accounting.

Specifically, it is an object of the present invention to provide a management accounting method and system considering the time value, and a program recording medium therefor. The accounting method and system can make a will decision in association with a target ROE set as a management target, can link calculations by the DCF method to be used in the will decision and accounting calculations, and can analyze the plan or result of the profit/loss calculations in each branch after the investment was executed, in association with a management target.

In order to achieve the above-specified object, there is provided a management accounting method considering a time value according to the present invention, comprising a first step of inputting the data of a target ROE, set as a management target, to target ROE input cells on the worksheet and storing them in the memory. A second step determines a before-tax WACC for the site and/or after-tax WACC for the head office by the calculation equations of the following Formula 1 and/or Formula 2 described in the cells on the worksheet, if the data of the target ROE stored in the memory at said first step are designated by the interest K_{E} of a stockholder's equity, and if the stockholder's equity is designated by E, the debt with interest by D, the rate of the debt with interest by K_{D}, the effective tax rate by t and the weighted average cost of capital by WACC. A third step determines a predicted cash flow CF by determining an earning before interest, tax, depreciation and amortization EBITDA from a predicted profit/loss statement and applies an operating fund and a fixed assets investment to the calculation equation of the following Formula 3 described in the cells on the worksheet. A fourth step of either determines a net present value NPV of said predicted CF by applying said side before-tax WACC as a discount rate to the calculation equation of the following Formula 4 described in the cells on the worksheet or determines the net present value NPV of said after-tax CF by applying said head office after-tax WACC as a discount rate to the calculation equation of said following Formula 4 described in the cells of the worksheet, wherein it is analyzed by calculating the net present value NPV of said predicted CF or said after-tax CF whether or not the investment has achieved the target ROE set as the management target.

Thus, the target ROE comes as a parameter into the calculations of the economic value of the time in the DCF method. Therefore, the will decision (or the DCF calculations) of the investment and the management target (or the target ROE) are associated with each other so that it can be made by analyzing whether or not the investment will achieve the target ROE set as the management target.

According to an embodiment of the invention, on the other hand, there is provided a management accounting method considering a time value, further comprising a fifth step of determining a capital cost or the time value by applying the B/S assets determined from a predicted balance sheet and said site before-tax WACC to the calculation equation of the following Formula 5 described in the cells of the worksheet; and a sixth step of determining the site before-tax net earning by applying the EBITDA determined from said predicted profit/loss statement, the depreciation expenses and said capital cost to the calculation equation of the following Formula 6 described in the cells on the worksheet, wherein it is analyzed by calculating said site before-tax net earning and its net present value NPV whether or not the plan of the profit/loss calculations has achieved the target ROE set as the management target.

According to a feature of the invention, there is provided a management accounting method considering a time value, further comprising a step of determining a creditor's capital cost or the time value by applying the B/S assets determined from a predicted balance sheet and the before-tax debt with interest to the calculation equation of the following Formula 7 described in the cells on the worksheet; a step of determining a stockholder's capital cost or the time value by applying the B/S assets determined from the predicted sheet balance and the rate of the after-tax stockholder's equity to the calculation equation of the following Formula 8 described in the cells on the worksheet; and a step of determining the head office after-tax net earning by applying the EBITDA determined from said predicted profit/loss statement, depreciation expenses, said creditor's capital cost, the tax and said stockholder's capital cost to the calculation equation of the following Formula 9, wherein it is analyzed by calculating said head office after-tax net earning and its net present value NPV whether or not the plan of the profit/loss calculations has achieved the target ROE set as the management target.

Thus, the before-tax net earnings are indicated to the site of each branch of the investment enterprise for judging the achievement of the plan with the before-tax numerical value, and the after-tax net earnings are indicated to each branch of the head office for judging the achievement of the plan with the after-tax numerical value of the entire enterprise. Therefore, the site actions (or the profit/loss calculations of each branch) and the management target (or the target ROE) can be associated to after-follow the will-decided contents for each branch by the profit/loss calculations. On the other hand, each practical branch action is evaluated with the net earnings which is calculated by adding the investment cost by the B/S assets on the basis of the branch profit/loss statement. Therefore, the result evaluations can be made considering not only the P/L but also the B/S to give an incentive for increasing the cash flow to the actions of each branch.

According to a further feature of the invention, there is provided a management accounting method considering a time value, further comprising a step of determining a capital cost or the time value by applying the B/S assets determined from the result of a balance sheet and said site before-tax WACC to the calculation equation of the following Formula 5 described in the cells on the worksheet; and a step of determining a site before-tax earning by applying the EBITDA determined from the result of said profit/loss statement, depreciation expenses and said capital cost to the calculation equation of the following Formula 6 described in the cells on the worksheet, wherein the result evaluation adding said capital cost is made by presenting the results of said site before-tax net earning as result indices.

According to another feature of the invention, there is provided a management accounting method considering a time value, further comprising a step of determining a creditor's capital cost or the time value by applying the B/S assets determined from the result of a balance sheet and the rate of the before-tax debt with interest to the calculation equation of the following Formula 7 described in the cells on the work sheet; a step of determining the stockholder's capital cost or the time value by applying the B/S assets determined from the result of the balance sheet and the rate of the after-tax stockholder's equity to the calculation equation of the following Formula 8 described in the cells on the work sheet; and a fourteenth step of determining the head office after-tax net earning by applying the EBITDA determined from the result of the profit/loss statement, the depreciation expenses, said creditor's capital cost, the tax and said stockholder's capital cost to the calculation equation of the following Formula 9 described in the cells of the worksheet, wherein the result of said head office after-tax net earning is presented as result indices to evaluate the results adding the stockholder's capital cost.

The conventional Japanese enterprise has been managed by centering on the profit/loss statement exclusively with little consideration into the balance sheet, so that its management structure conscious of the necessary minimum earning for the stockholders, i.e., the capital cost, has not been established. If the result of the net earning excepting the capital cost is presented as the result index, on the contrary, the result evaluation can be made by adding the capital cost thereby to establish the management structure conscious of the necessary minimum earning for the stockholders. Depending upon whether or not the result index adding the capital cost is more than 0, moreover, it is possible to evaluate whether or not the profit has exceeded the target ROE.

According to a feature of the invention, there is provided a management accounting method considering a time value, further comprising a step of displaying the site profit/loss statement containing capital cost display cells and before-tax net earning display cells and/or the head office profit/loss statement containing stockholder's capital cost display cells and after-tax net earning display cells.

Thus, in terms of the values displayed in the capital cost display cells or the stockholder's capital cost cells, the capital cost or the stockholder's capital cost can be grasped to do the result evaluations conscious of the capital cost.

According to another embodiment of the invention, there is provided a management accounting system comprising means for realizing the individual steps constructing the management accounting method considering a time value according to any the above aspects of the present invention.

According to a further embodiment of the invention, there is provided a computer-readable recording medium recorded with programs for causing a computer to execute the individual steps constructing the management accounting method considering a time value according to any of the above aspects of the present invention.

A management accounting method considering a time value according to the present invention preferably uses a computer system as a hardware resource, including data storage means for storing inputted data in a worksheet on a memory; data display means for displaying the worksheet on said memory; and calculation means for operating according to calculation equations described in the cells on said worksheet. According to a mode of embodiment of the method of the invention, moreover, it is preferably to use general-purpose spreadsheet programs which are provided with data storage means, data display means and calculation means. It is, however, quite natural to use the dedicated programs which are individually designed and developed. On the other hand, the programs may be executed by combining them with programs for financial accounting, cost calculating, management simulation or investment project analyzing programs or by incorporating them as a portion of a business accounting system. Moreover, the programs can also be down-loaded via the internet or used by the software lending services. The programs for causing the computer to execute the individual steps constructing the management accounting method considering a time value according to the present invention will be called the “present programs”.

The general-purpose spreadsheet programs are constructed by centering an electronic accumulation table. As numerical values or calculation equations are inputted to the measures of the accumulation table, the calculation results are automatically displayed on the measures of the accumulation table. In the field of the spreadsheet programs, generally speaking, the accumulation table is called the “worksheet”, and the measures are called the “cells”.

The worksheet is constructed by arranging the cells in a checkerboard shape, and the cells are administered with the information of rows and columns they belong to. Each cell is set with a cell address specifying it uniquely, and this cell address is used mainly when the data of another cell are referred to in a calculation equation. When the calculation equations of the following Formulas 1 to 9 are to be calculated on the present programs, therefore, the calculation equation can be described in one cell. However, another construction may be made to achieve the identical calculation result by decomposing and describing the calculation equation into a plurality of cells and by quoting the calculation result with the cell address.

When a cell is to be stored with data by using the data storage means, it is designated with a mouse, and a return key is depressed after the data were inputted. The input data are stored in the cell. To the cell, there can be inputted numerical values or calculation equations. The calculation equation to be inputted as the calculation means may be the four rules of arithmetic so that various functions such as totalizing, averaging, maximizing or minimizing functions can also be inputted.

When the data stored in the cell are to be displayed by the data display means, they are displayed as they are on the cell if they are numerical values. If the stored data are calculation equations, on the other hand, the value of the calculation result is displayed on the cell.

On the other hand, the mode of embodiment of a management accounting system according to a feature of the invention is specified by:

(1) a management accounting system comprising: means for executing a first step of inputting the data of a target ROE set as a management target, to target ROE input cells on the worksheet and storing them in the memory; means for executing a second step of determining a before-tax WACC for the site and/or after-tax WACC for the head office by the calculation equations of the following Formula 1 and/or Formula 2 described in the cells on the worksheet, if the data of the target ROE stored in the memory at said first step executing means are designated by the interest K_{E} of a stockholder's equity, and if the stockholder's equity is designated by E, the debt with interest by D, the rate of the debt with interest by K_{D}, the effective tax rate by t and the weighted average cost of capital by WACC; means for executing a third step of determining a predicted cash flow CF by determining an earning before interest, tax, depreciation and amortization EBITDA from a predicted profit/loss statement and by applying an operating fund and a fixed assets investment to the calculation equation of the following Formula 3 described in the cells on the worksheet; and means for executing a fourth step of either determining a net present value NPV of said predicted CF by applying said side before-tax WACC as a discount rate to the calculation equation of the following Formula 4 described in the cells on the worksheet or determining the net present value NPV of said after-tax CF by applying said head office after-tax WACC as a discount rate to the calculation equation of said following Formula 4 described in the cells of the worksheet, wherein it is analyzed by calculating the net present value NPV of said predicted CF or said after-tax CF whether or not the investment has achieved the target ROE set as the management target;

(2) a management accounting system according to (1) further comprising: means for executing a fifth step of determining a capital cost or the time value by applying the B/S assets determined from a predicted balance sheet and said site before-tax WACC to the calculation equation of the following Formula 5 described in the cells of the worksheet; and means for executing a sixth step of determining the site before-tax net earning by applying the EBITDA determined from said predicted profit/loss statement, the depreciation expenses and said capital cost to the calculation equation of the following Formula 6 described in the cells on the worksheet, wherein it is analyzed by calculating said site before-tax net earning and its net present value NPV whether or not the plan of the profit/loss calculations has achieved the target ROE set as the management target;

(3) A management accounting system according to (1) further comprising: means for executing a seventh step of determining a capital cost or the time value by applying the B/S assets determined from the result of a balance sheet and said site before-tax WACC to the calculation equation of the following Formula 5 described in the cells on the worksheet; and means for executing an eighth step of determining a site before-tax earning by applying the EBITDA determined from the result of said profit/loss statement, depreciation expenses and said capital cost to the calculation equation of the following Formula 6 described in the cells on the worksheet, wherein the result evaluation adding said capital cost is made by presenting the results of said site before-tax net earning as result indices;

(4) a management accounting system according to (1) further comprising: means for executing a ninth step of determining a creditor's capital cost or the time value by applying the B/S assets determined from a predicted balance sheet and the before-tax debt with interest to the calculation equation of the following Formula 7 described in the cells on the worksheet; means for executing a tenth step of determining a stockholder's capital cost or the time value by applying the B/S assets determined from the predicted sheet balance and the rate of the after-tax stockholder's equity to the calculation equation of the following Formula 8 described in the cells on the worksheet; and means for executing an eleventh step of determining the head office after-tax net earning by applying the EBITDA determined from said predicted profit/loss statement, depreciation expenses, said creditor's capital cost, the tax and said stockholder's capital cost to the calculation equation of the following Formula 9, wherein it is analyzed by calculating said head office after-tax net earning and its net present value NPV whether or not the plan of the profit/loss calculations has achieved the target ROE set as the management target;

(5) a management accounting system according to (1), further comprising: means for executing a twelfth step of determining a creditor's capital cost or the time value by applying the B/S assets determined from the result of a balance sheet and the rate of the before-tax debt with interest to the calculation equation of the following Formula 7 described in the cells on the work sheet; means for executing a thirteenth step of determining the stockholder's capital cost or the time value by applying the B/S assets determined from the result of the balance sheet and the rate of the after-tax stockholder's equity to the calculation equation of the following Formula 8 described in the cells on the work sheet; and means for executing a fourteenth step of determining the head office after-tax net earning by applying the EBITDA determined from the result of the profit/loss statement, the depreciation expenses, said creditor's capital cost, the tax and said stockholder's capital cost to the calculation equation of the following Formula 9 described in the cells of the worksheet, wherein the result of said head office after-tax net earning is presented as result indices to evaluate the results adding the stockholder's capital cost; and

(6) a management accounting system according to any of (2) to (5) further comprising: means for executing a fifteenth step of displaying the site profit/loss statement containing capital cost display cells and before-tax net earning display cells and/or the head office profit/loss statement containing stockholder's capital cost display cells and after-tax net earning display cells.

Moreover, the management accounting system according to the present invention can be practiced either by a general-purpose computer system in which programs for realizing the individual steps of the present invention are installed, or as a dedicated device in which there are packaged data storage means, data display means and calculation means such as a CPU, a memory and a CRT. Moreover, the management accounting system according to the invention can be practiced either by a business accounting system having functions of the financial accounting, the cost calculation, the management simulation and the investment project analysis or by a client-server system via the networks. Then, the data display means can be constructed as a remote terminal via communication lines such as the internet.

Moreover, the embodiment of a computer-readable program recording medium according to the invention is specified by a computer-readable recording medium recorded with programs for causing a computer to execute said first to fourth steps constructing the management accounting method considering the time value; a computer-readable recording medium recorded with programs for causing a computer to execute said first to sixth steps constructing the management accounting method considering the time value; a computer-readable recording medium recorded with programs for causing a computer to execute said first to fourth steps and said seventh and eighth steps constructing the management accounting method considering the time value; a computer-readable recording medium recorded with programs for causing a computer to execute said first to fourth steps and said ninth to eleventh steps constructing the management accounting method considering the time value; a computer-readable recording medium recorded with programs for causing a computer to execute said first to fourth steps and said twelfth to fourteenth steps constructing the management accounting method considering the time value; and a computer-readable recording medium recorded with programs for causing a computer to execute the individual steps constructing the management accounting method considering the time value, that is, not only the individual steps constructing the programs of the individual recording medium thus far described but also the fifteenth step of the management accounting method considering the time value. Moreover, the recording medium can be embodied, if necessary, by the floppy disk, the CD, the DVD or the cartridge type magnetic tape. On the other hand, the present programs may be pre-installed in the magnetic disk of a personal computer, for example.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a diagram for explaining a first screen of the present invention containing target ROE cells.

FIG. 2 is a diagram for explaining a second screen of the present invention.

FIG. 3 is a diagram for explaining a third screen of the present invention, containing capital cost display cells, before-tax net earning display cells, stockholder's equity cost display cells, and after-tax net earning display cells.

FIG. 4 is a diagram for explaining a fourth screen of the present invention, containing capital cost display cells, before-tax net earning display cells, stockholder's equity cost display cells, and after-tax net earning display cells.

### DETAILED DESCRIPTION OF THE INVENTION

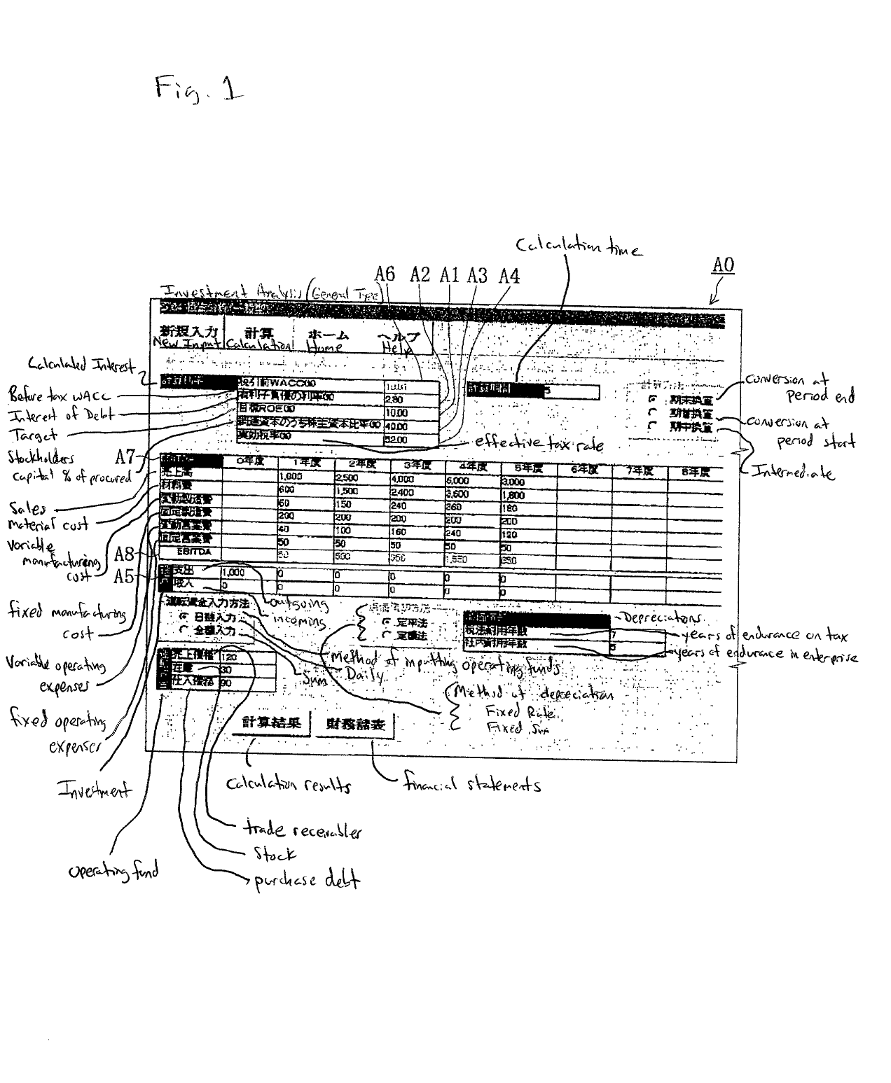

The present program will be described in connection with one embodiment with reference to FIGS. 1 to 4.

FIG. 1 is an explanatory view of a first screen A0 of the present invention. In FIG. 1 reference character A1 designates target ROE cells for inputting a target ROE (%) set as a management target; A2 designates cells for inputting a percentage (%) of interest debt; A3 designates cells for inputting the percentage (%) of the occupation of the stockholder's equity in a procured capital; A4 designates cells for inputting an input tax rate (%); A5 designates cells for inputting an investment sum (in ten thousand: ┌); and A6 designates cells for displaying a before-tax WACC calculated.

In the present embodiment, as one example of the first step, a value “10.00” (%) is inputted to the target ROE input cells Al and is stored in a memory. On the other hand, numerical values “2.80”, “40.00”, “52.00” and “1,000” are inputted to A2, A3, A4 and A5, respectively, and are individually stored in the memory.

As the second step in the programs of this embodiment of the present invention, an equation for calculating Formula 1 is described in the cells A6 on the basis of the data inputted to A1 to A5. For stockholder's equity E and interest debt D, however, the following preliminary calculations are made before the execution of the calculation of Formula 1. In the aforementioned example, more specifically, the data inputted to A3 are “40%” so that the stockholder's equity E is calculated by “┌10,000,000×0.4=┌4,000,000” where the interest debt D is calculated by “┌10,000,000−┌4,000,000=┌6,000,000”.

In the aforementioned Formula 1, therefore, the second step is executed with D=“┌6,000,000”, with E=“┌4,000,000”, with an interest rate K_{D} of the interest debt being at “2.8%” inputted to cell A2, with an interest rate K_{E} of the stockholder's equity being at “10%” inputted to cell A1 and with an effective tax rate t being at “52%” inputted to cell A4. Then, the before-tax WACC is determined to 10.01%, as expressed by the following Formula 12. In the present embodiment, this before-tax WACC, as determined by this calculation”, is displayed in A6.

$$\frac{600 \times 2.8 \% + 400 \times 10 \% / ( 1 - 0.52 )}{600 + 400} = 0.1001 \qquad Formula 12$$

On the other hand, the programs of the present embodiment are provided with cells in which there is described an equation as the second step for determining the after-tax WACC by giving the aforementioned data to the foregoing Formula 2. Specifically, the calculation Equation of the Formula 2 is executed with D=“┌6,000,000”, with E=“┌4,000,000”, with the interest rate K_{D} of the interest debt being at “2.8%” inputted to A2, with the interest rate K_{E} of the stockholder's equity being at “10%” inputted to A1 and with the effective tax rate t being at “52%” inputted to A4. Then, the after-tax WACC is determined to 4.8%, as expressed by the following Formula 13.

$$\frac{( 1 - 0.52 ) \times 600 \times 2.8 \% + 400 \times 10 \%}{600 + 400} = 0.0480 \qquad Formula 13$$

In FIG. 1, characters A7 designate cells for inputting “sales”, “material cost”, “variable manufacturing cost”, “fixed manufacturing cost”, “variable operating expenses” and “fixed operating expenses”, as predicted in each year, and A8 designate cells for determining an earning before interest, tax, depreciation and amortization EBITDA from the input data and displaying it.

The cells A8 describe a calculation equation for subtracting the “material cost”, “variable manufacturing cost”, “fixed manufacturing cost”, “variable operating expenses” and “fixed operating expenses” from the “sales”. In the present embodiment, therefore, the EBITDA is calculated to “┌500,000” in the first year, “┌5,000,000” in the second year, “┌9,500,000” in the third year, “┌15,500,000” in the fourth year and “┌6,500,000” in the fifth year, and these data of calculation results are displayed.

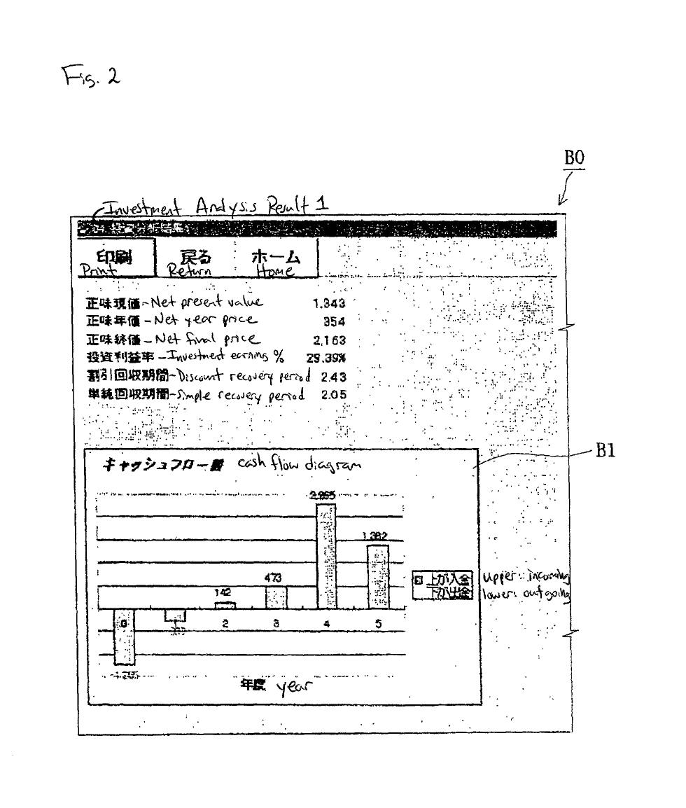

Here will be calculated the cash flow on the basis of the data of the EBITDA thus determined. FIG. 2 is an explanatory diagram expressing a second screen B0 of the present embodiment. Reference characters B1 designate a graph drawing field of a prediction CF.

Here, it is assumed that the data of fixed assets, trade receivables, stock and purchase debt are not shown but given from another screen, as enumerated in the following Table 2. In each year, the “operating fund” is calculated by “trade receivables+stock−purchase debt”, and the “necessary assets” are calculated by “fixed assets+operating fund”.

TABLE 2
Unit: ¥ 10,000

| | 0th | 1st | 2nd | 3rd | 4th |
|---|---|---|---|---|---|
| Fixed Assets | 1000 | 631 | 398 | 251 | 158 |
| Trade Receivables | 333 | 833 | 1333 | 2000 | 1000 |
| Stock | 72 | 154 | 237 | 347 | 182 |
| Purchase Debt | 150 | 375 | 600 | 900 | 450 |
| Operating Fund | 255 | 612 | 970 | 1447 | 732 |
| Necessary Assets | 1255 | 1243 | 1368 | 1698 | 890 |

Therefore, the “operating fund increases” to be used in the calculation equation of the aforementioned Formula 3 may be calculated by subtracting the operating fund of the previous year from that of this year so that they can be calculated by “255−0=┌2,550,000” on the 0th year, “612−255=┌3,570,000” on the 1st year, “970−612=┌3,580,000” on the 2st year, “1447−970=┌4,770,000” on the 3rd year, and “732−1447=┌−7,150,000” on the 4th year. On the other hand, the “fixed assets investment” is “┌10,000,000” in the 0th year but “┌0” in the remaining years, as shown at A5 in FIG. 1.

The programs of the present embodiment are provided with cells in which there is described a calculation equation as the third step for determining the predicted CF by applying the data of the EBITDA, the operating fund increase and the fixed assets investment, as determined from the predicted profit/loss statement, to the aforementioned Formula 3. Specifically, the predicted CF is determined by “EBITDA−operating fund increase−fixed assets investment”, as defined by the Formula 3. In the present embodiment, therefore, the predicted CF is calculated to “0−255−1,000=┌−12,550,000” in the 0th year, “50−357−0=┌3,070,000” in the 1 st year, “500−358−0=┌1,420,000” in the 2nd year, “950−477−0=┌4,730,000” in the 3rd year, and “1550−(−715)−0=┌22,650,000” in the 4th year. In the present embodiment, the values of the predicted cash flow, as determined by the aforementioned calculations, are displayed in the graph drawing field B1 of the predicted CF in FIG. 2.

Next, the after-tax CF is calculated from the predicted CF thus determined. It is assumed that the data of “depreciation expenses” are given from another screen, as enumerated in the following Table 3. The “taxable incomes” may be calculated by subtracting the depreciation expenses from the aforementioned EBITDA so that they can be calculated to “50−369=┌3,190,000” in the 1st year, “500−233=┌2,670,000” in the 2nd year, “950−147=┌8,030,000” in the 3rd year, and “1,550−93=┌14,570,000” in the 4th year. The “cooperation tax, etc.” is determined by multiplying that “taxable income” by the “effective tax rate”, and the “after-tax CF” is calculated by subtracting the “cooperation tax, etc.” from the predicted CF.

TABLE 3
Unit: ¥ 10,000

| | 0th | 1st | 2nd | 3rd | 4th |
|---|---|---|---|---|---|
| Predicted CF | −1225 | −307 | 142 | 473 | 2265 |
| Depreciation Expenses | | 369 | 233 | 147 | 93 |
| Taxable Income | | −319 | 267 | 803 | 1457 |
| Cooperation Income, etc. | | −166 | 139 | 418 | 758 |
| After-Tax CF | −1225 | −141 | 3 | 55 | 1507 |

Moreover, the programs of the present embodiment are provided with cells in which there is described a calculation equation as the fourth step for determining a net present value of the after-tax CF determined in the Table 3 by applying the after-tax WACC “4.8%” determined at the aforementioned second step, as the discount rate to the Formula 4. Specifically, the after-tax CF of each year is multiplied by the depreciation factor using the after-tax WACC “4.8%” as the discount rate:

| | | | |
|---|---|---|---|
| 0th | year = | −1,255 | |
| 1st | year = | −141 | /(1 + 0.048)¹ = −135 |
| 2nd | year = | 3 | /(1 + 0.048)² = 3 |
| 3rd | year = | 55 | /(1 + 0.048)³ = 48 |
| 4th | year = | 1,507 | /(1 + 0.048)⁴ = 1249 |
| 5th | year = | 1,126 | /(1 + 0.048)⁵ = 891. |

Thus, the net present value of the after-tax cash flow is “(−1,255)+(−135)+3+48+1,249+891=801”. Therefore, the investment of the present embodiment is judged to have achieved the target ROE in the 5th year because the net present value is no less than 0. Here in the present embodiment, the after-tax WACC is fixed at 4.8% over a planned period but may be varied for every years in accordance with the change in the financial constructions in the lapse of years or the change in the target ROE.

Thus, in the present embodiment, the will decision and the management target are associated with each other. It is possible to judge whether or not the investment achieves the target ROE set as the management target. Therefore, it is possible to solve the problem of the prior art which has failed to judge whether or not the investment has achieved the management target (or the target ROE).

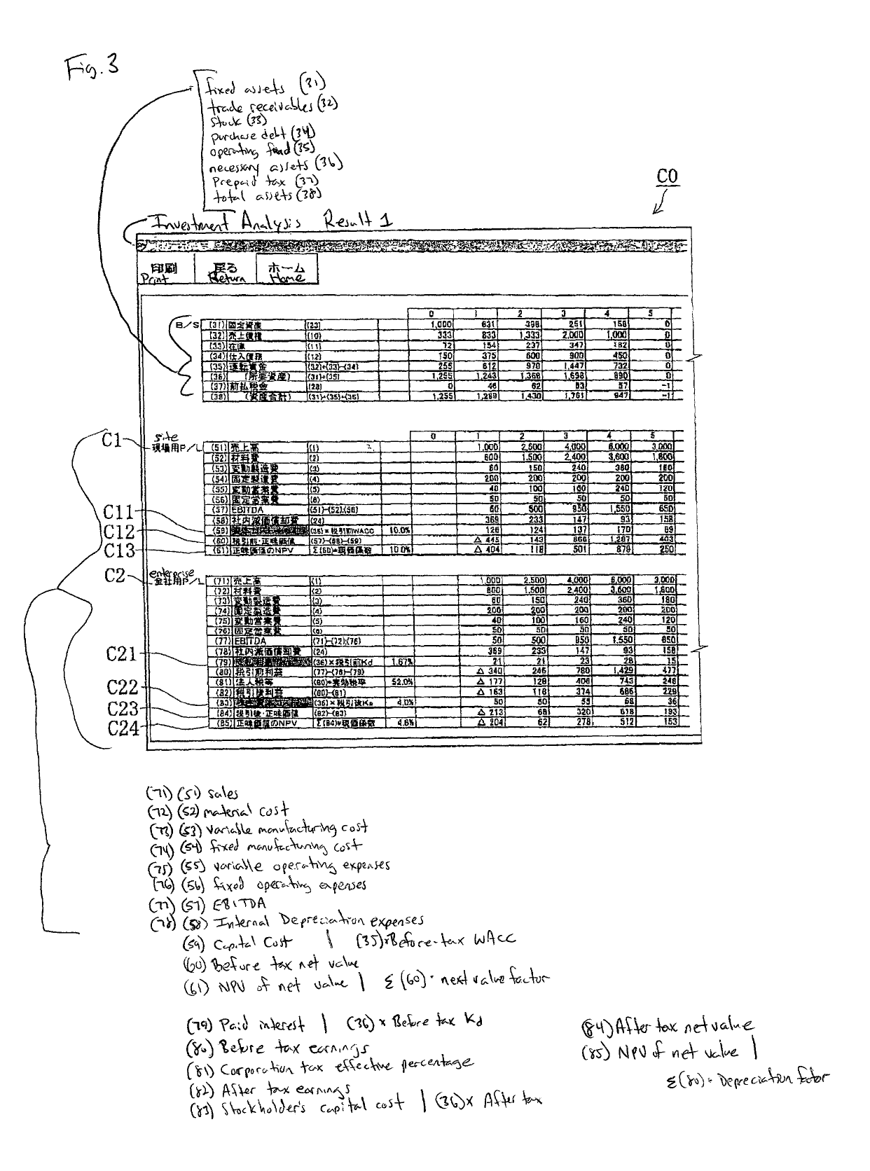

FIG. 3 is an explanatory diagram of a third screen CO in the present embodiment. This third screen is provided for planning the profit/loss calculations for every branches after the investment was executed. The third screen is provided with a display field C1 for a site P/L and a display field C2 for a head office P/L. On the other hand: reference characters C11 designate capital cost display cells; C 12 before-tax net profit display cells; C22 stockholder's equity cost display cells; and C23 after-tax net earning display cells.

In the site P/L display field C1, the method for determining the EBITDA is identical to the aforementioned one of FIG. 1. Here in the present embodiment, there is described an instruction to quote the desired data on the worksheet of FIG. 1 in terms of the cell address so that the data may not be inputted again.

The programs of the present embodiment are provided with the cells 11 in which there is described the calculation equation as the fifth step for determining the capital cost or the time value by applying the data of the B/S assets and the site before-tax WACC to the aforementioned Formula 5. Specifically, the “capital cost” is determined by multiplying the “necessary assets (B/S assets)” of the preceding year, as has been determined in the aforementioned Table 2, by the “site before-tax WACC=10.01%” determined by the aforementioned Formula 12. In the present embodiment, the cells C11 are provided as the fifteenth step for displaying the “capital cost” determined as above.

The programs of the present embodiment are further provided with the cells C 12 in which there is described a calculation equation as the sixth step for determining the before-tax net earning for the site by applying the data of the EBITDA, the depreciation expenses and the capital cost determined from the predicted profit/loss statement, to the aforementioned Formula 6. Specifically, the “site before-tax net earning” is determined by subtracting the depreciation expenses and the capital cost determined at the aforementioned fifth step, from the EBITDA of each year.

In the present embodiment, there are provided the cells C12 as the fifteenth step for displaying the “site before-tax net earnings” determined at the sixth step. Against the before-tax net earnings, moreover, the net present value NPV is calculated by using the site before-tax WACC as the discount rate, and the result is displayed in cells C13. In the present embodiment, the net present value NPV is calculated to “(−404)+118+501+879+250=1,333” more than 0. It is, therefore, judged that the plan of the profit/loss calculations for the site has achieved the target ROE.

Here will be described the head office P/L display field C2. The method for determining the EBITDA is identical to the aforementioned method of FIG. 1. In the present embodiment, there is described an instruction to quote the desired data on the worksheet of FIG. 1 as the cell addresses so that the data may not be inputted again.

The programs of the present embodiment are provided with: the cells C21 in which there is described a calculation equation as the ninth step for determining the creditor's capital cost by applying the B/S assets and the rate of the before-tax debt with interest to the aforementioned Formula 7; and the cells C22 in which there is described a calculation equation as the tenth step for determining the stockholder's equity cost by applying the B/S assets and the rate of the after-tax stockholder's equity to the aforementioned Formula 8. First of all, more specifically, the “creditor's capital cost” is determined by multiplying the “necessary assets (B/S assets)” determined in the aforementioned Table 2, by the rate “1.67%” of the before-tax debt with interest. In the present embodiment, as the fifteenth step, the “creditor's capital cost” thus determined is displayed in the cells C21.

The “stockholder's equity cost” or the time value is determined by multiplying the “necessary assets (B/S assets)” determined from the aforementioned Table 2, by the rate “4.0%” of the after-tax stockholder's equity. Moreover, the “after-tax net earnings for the head office” are determined by subtracting the depreciation expenses, the creditor's capital cost, the taxes and the stockholder's equity cost from the EBITDA of each year.

In the present embodiment, there are provided, as the fifteenth step, the cells C22 for displaying the “stockholder's equity cost” determined at the tenth step and the cells C23 for displaying the “after-tax net earnings for the head office” determined at the eleventh step. Against this after-tax net earnings, moreover, the net present value NPV is calculated by using the head office after-tax WACC as the discount ratio, and the result is displayed in the cells C24. In the present embodiment, the net present value NPV is calculated to “(−204)+62+278+512+153=801” more than 0. It is, therefore, judged that the plan of the profit/loss calculations for the head office has achieved the target ROE.

Thus, each branch can be evaluated with the net earnings which have been calculated by considering the capital cost on the basis of the predicted profit/loss statement. Therefore, the site actions (or the profit/loss calculation for each branch) and the management target (or the target ROE) are associated so that the will-decided content can be after-followed with the profit/loss calculation.

As to the taxes, on the other hand, the site can be evaluated before the taxes whereas the head office can be evaluated after the taxes, so that the individual branches can be analyzed according to their accounting situations. In addition, there are provided the capital cost display cells C11, the stockholder's equity cost display cells C22, the before-tax net earning display cells C12 and the after-tax net earning display cells C23 so that the individual branches can plan the profit/loss calculations while being conscious of the capital cost and the net earnings.

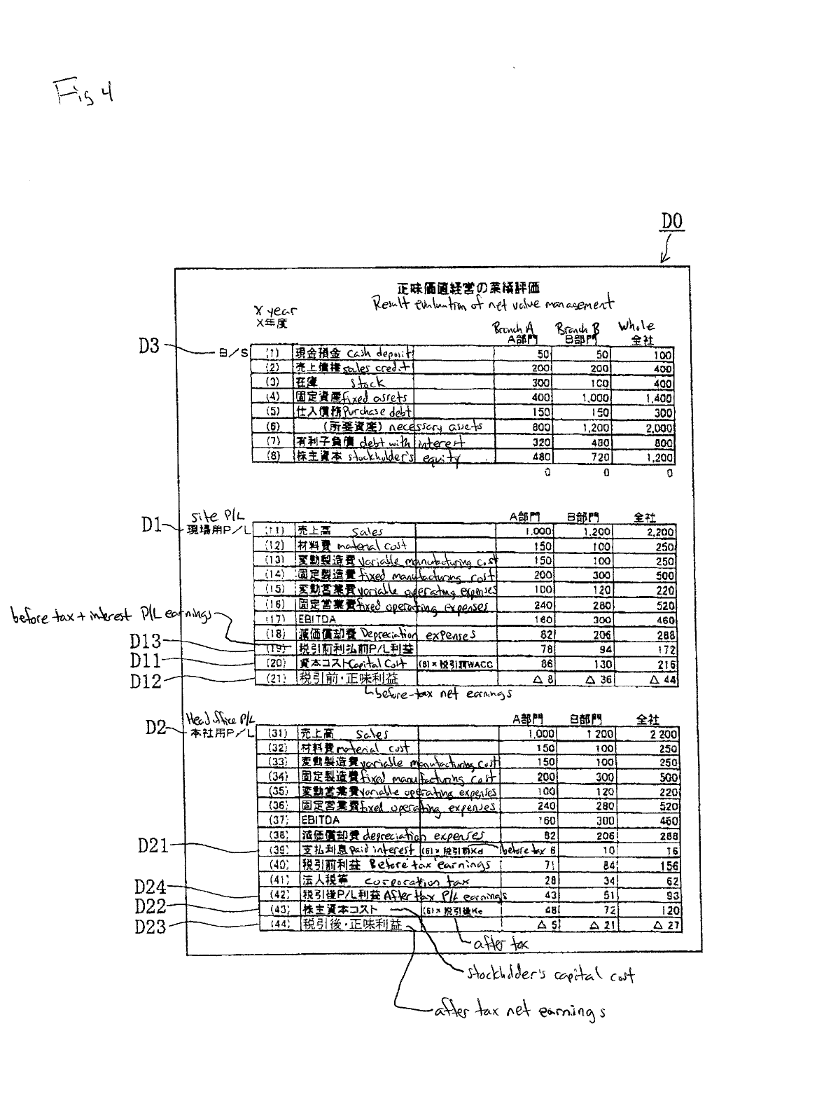

FIG. 4 is an explanatory diagram of a fourth screen D0 in the present embodiment. This fourth screen D0 is one for evaluating the past results of the profit/loss calculations of the individual branches. The fourth screen D0 is provided with a result display field D1 for the site P/L, a result display field D2 for the head office and a result display field D3 for the balance sheet B/S. Here, the data of results in a year are inputted to the cells of the individual fields.

In FIG. 4: reference characters D11 designate capital cost display cells; D12 before-tax net earning display cells; D22 paid interest display cells; and D23 after-tax net earning display cells. The calculation equations to be described in the individual cells are identical to those used in the case of planning the profit/loss calculations, as described with reference to FIG. 3. For the calculation equations described in the cells: the calculation equation at the seventh step is identical to that of the fifth step; the calculation equation at the eighth step is identical to that of the sixth step; the calculation equation at the twelfth step is identical to that of the ninth step; the calculation equation at the thirteenth step is identical to that of the tenth step; and the calculation equation at the fourteenth step is identical to that of the twelfth step. On the other hand, characters D13 designates before-tax/-interest P/L earnings, and D24 after-tax P/L earnings.

As the result evaluations in the prior art, the before-tax/-interest P/L earnings D13 were used at the site, and the after-tax P/L earnings D24 were used at the head office. In other words, the conventional Japanese enterprises have been managed centering the profit/loss calculations, but there have never been established the management structures which are conscious of the capital cost or the necessary minimum earnings for the stockholders.

In the present embodiment, on the contrary: at the eighth step, there are presented the results of the before-tax net earnings D12 which are calculated by subtracting the capital cost D11 from the before-tax/-interest P/L benefits D13; at the fourteenth step, there are presented the after-tax net earnings D23 which are calculated by subtracting the stockholder's equity cost D22 from the after-tax P/L earnings D24; and at the fifteenth step, the capital cost, the before-tax net earnings, the stockholder's equity cost and the after-tax net earnings are displayed in the aforementioned cells D11, D12, D22 and D23. If the before-tax net earnings D12 or the after-tax net earnings D23 are used the result indices, therefore, it is possible to establish the management structure which is conscious of the necessary minimum earnings for the stockholders. In dependence upon whether or not the result indices conscious of the capital cost exceed 0, it is possible to evaluate whether or not there are earnings over the target ROE.

Here in the present embodiment, the site P/L display field C1 and the head office P/L display field C2 are displayed on the common screen in FIG. 3, and the site P/L result display field D1 and the head office P/L result display field D2 are displayed on the common screen in FIG. 4. However, it is naturally arbitrary that the two fields are displayed on different screens.

According to the management accounting method and system and the program recording medium considering the time value of the present invention, as has been described hereinbefore, the target ROE goes as a parameter into the calculations of the economic value of the time in the DCF method. It is, therefore, possible to associate the will decision (or the DCF calculations) of the investment and the management target (or the target ROE) with each other. Therefore, there is obtained an effect that whether or not the investment can achieve the target ROE set as the management target is analyzed to analyze the economy of the investment so that the will decision of the investment can be made.

In the management accounting method and system and the program recording medium considering the time value of the present invention, on the other hand, it is possible to perform the calculations by the DCF method and the accounting calculations interchangeably. Therefore, the will-decided contents can be after-followed by the profit/loss calculations. On the other hand, the capital cost and the net earnings are calculated and are developed to be displayed into the site profit/loss statement or the head office profit/loss statement. Therefore, each branch can grasp the profit/loss statements on the basis of the capital used by itself so that it can understand the management target specifically in relation to the stock, the trade receivables, the facilities and so on. By using the management accounting method and system and the program recording medium considering the time value according to the present invention, therefore, there is obtained another effect that the management target is associated with the site actions. Moreover, the conventional Japanese enterprises have made the result evaluations by centering the profit/loss calculations. By using the management accounting method and system and the program recording medium considering the time value according to the present invention, however, it is possible to make the result evaluations systematizing both the capital efficiency considering not only the profit/loss calculations but also the capital employed and the cash flow increase.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A management accounting method considering a time value for providing economic information on an enterprise comprising:
a first step of inputting the data of a target return on equity, ROE, to target ROE input cells on a worksheet;
a second step of determining at least one of a before-tax WACC for the site and an after-tax WACC for the head office by the calculation equations of the following Formula 1 and Formula 2
$$\begin{matrix}Site Before \text{-} Tax WACC = \frac{{K}_{D} \cdot D + {K}_{E} \cdot E / ( 1 - t )}{D + E} & Formula 1 \\ Head Office After \text{-} Tax WACC = \frac{{K}_{D} \cdot D \times ( 1 - t ) + {K}_{E} \cdot E}{D + E} & Formula 2\end{matrix}$$
wherein the data of the target ROE of said first step are designated by the interest K_{E} of a stockholder's equity, and the stockholder's equity is designated by E, the debt with interest by D, the rate of the debt with interest by K_{D}, the effective tax rate by t and the weighted average cost of capital by WACC;
a third step of determining a predicted cash flow, CF, by determining an earning before interest, tax, depreciation and amortization, EBITDA, from a predicted profit/loss statement and by applying an operating fund and a fixed assets investment to the calculation equation of the following Formula 3
Predicted CF=EBITDA−Operating Fund Increase−Fixed Assets Investment; Formula 3
and
a fourth step of either one of determining a net present value, NPV, of said predicted CF by applying said site before-tax WACC as a discount rate to the calculation equation of the following Formula 4, or determining the net present value, NPV, of said after-tax CF by applying said head office after-tax WACC as a discount rate to the calculation equation of said following Formula 4
$$Net Present Value NPV of Predicted CF or After \text{-} Tax CF = \sum \frac{ \begin{matrix}Predicted CF or \\ After \text{-} Tax CF\end{matrix} }{{( 1 + Discount Rate )}^{t}} \qquad Formula 4$$
wherein analysis is preformed by calculating the net present value NPV of one of said predicted CF and said after-tax CF whether or not the investment has achieved the target ROE set as the management target.

2. The management accounting method according to claim 1 wherein said worksheet is on a memory component of a data storage means of a computer system, said computer system further comprising data display means for displaying said worksheet on said memory and calculation means for operating according to calculations equations described in the cells on said worksheet.

3. The management accounting method considering a time value according to claim 2, further comprising:
a fifth step of determining a capital cost or the time value by applying the B/S assets determined from a predicted balance sheet and said site before-tax WACC to the calculation equation of the following Formula 5,
$$Capital Cost = B / S Assets \times Site Before \text{-} Tax WACC ; \qquad Formula 5$$
and
a sixth step of determining the site before-tax net earning by applying the EBITDA determined from said predicted profit/loss statement, the depreciation expenses and said capital cost to the calculation equation of the following Formula 6,
Site Before-Tax Net Earning=EBITDA−Depreciation Expenses−Capital Cost; Formula 6
wherein analysis is performed by calculating said site before-tax net earning and said net present value NPV whether or not the plan of the profit/loss calculations has achieved the target ROE.

4. The management accounting method considering a time value according to claim 2, further comprising:
a seventh step of determining a capital cost or the time value by applying the B/S assets determined from the result of a balance sheet and said site before-tax WACC to the calculation equation of the following Formula 5,
Capital Cost=B/S Assets×Site Before-Tax WACC; Formula 5
and
an eighth step of determining a site before-tax earning by applying the EBITDA determined from the result of said profit/loss statement, depreciation expenses and said capital cost to the calculation equation of the following Formula 6,
Site Before-Tax Net Earning=EBITDA−Depreciation Expenses−Capital Cost; Formula 6
wherein the result evaluation adding said capital cost is made by presenting the results of said site before-tax net earning as result indices.

5. The management accounting method considering a time value according to claim 2, further comprising:
a ninth step of determining a creditor's capital cost or the time value by applying the B/S assets determined from a predicted balance sheet and the before-tax debt with interest to the calculation equation of the following Formula 7,
Creditor's Capital Cost=B/S Assets×Rate of Before-Tax Debt with Interest; Formula 7
a tenth step of determining a stockholder's capital cost or the time value by applying the B/S assets determined from the predicted sheet balance and the rate of the after-tax stoclholder's equity to the calculation equation of the following Formula 8,
Stockholder's Capital Cost=B/S Assets×Rate of After-Tax Stockholder's Equity; Formula 8
and
an eleventh step of determining the head office after-tax net earning by applying the EBITDA determined from said predicted profit/loss statement, depreciation expenses, said creditor's capital cost, the tax and said stockholder's capital cost to the calculation equation of the following Formula 9,
$$Head Office After \text{-} Tax Net Earnings = EBITDA - Depreciation Expenses - Creditor ' s Capital Cost - Tax - Stockholder ' s Capital Cost \qquad Formula 9$$
wherein it is analyzed by calculating said head office after-tax net earning and its net present value NPV whether or not the plan of the profit/loss calculations has achieved the target ROE set as the management target.

6. The management accounting method considering a time value according to claim 2, further comprising:
a twelfth step of determining a creditor's capital cost or the time value by applying the B/S assets determined from the result of a balance sheet and the rate of the before-tax debt with interest to the calculation equation of the following Formula 7,
Creditor's Capital Cost=B/S Assets×Rate of Before-Tax Debt with Interest; Formula 7
a thirteenth step of determining the stockholder's capital cost or the time value by applying the B/S assets determined from the result of the balance sheet and the rate of the after-tax stockholder's equity to the calculation equation of the following Formula 8,
Stockholder's Capital Cost=B/S Assets×Rate of After-Tax Stockholder's Equity; Formula 8
and
a fourteenth step of determining the head office after-tax net earning by applying the EBITDA determined from the result of the profit/loss statement, the depreciation expenses, said creditor's capital cost, the tax and said stockholder's capital cost to the calculation equation of the following Formula 9,
$$Head Office After \text{-} Tax Net Earnings = EBITDA - Depreciation Expenses - Creditor ' s Capital Cost - Tax - Stockholder ' s Capital Cost \qquad Formula 9$$
wherein the result of said head office after-tax net earning is presented as result indices to evaluate the results adding the stockholder's capital cost.

7. The management accounting method considering a time value according to any of claim 3, further comprising:
a fifteenth step of displaying at least one of the site profit/loss statement containing capital cost display cells and before-tax net earning display cells and the head office profit/loss statement containing stockholder's capital cost display cells and after-tax net earning display cells.

8. The management accounting method considering a time value according to any of claim 4, further comprising:
a fifteenth step of displaying at least one of the site profit/loss statement containing capital cost display cells and before-tax net earning display cells and the head office profit/loss statement containing stockholder's capital cost display cells and after-tax net earning display cells.

9. The management accounting method considering a time value according to any of claim 5, further comprising:
a fifteenth step of displaying at least one of the site profit/loss statement containing capital cost display cells and before-tax net earning display cells and the head office profit/loss statement containing stockholder's capital cost display cells and after-tax net earning display cells.

10. The management accounting method considering a time value according to any of claim 6, further comprising:
a fifteenth step of displaying at least one of the site profit/loss statement containing capital cost display cells and before-tax net earning display cells and the head office profit/loss statement containing stockholder's capital cost display cells and after-tax net earning display cells.

11. A management accounting system comprising:
means for realizing the individual steps constructing of said management accounting method considering a time value according to claim 1.

12. A management accounting system comprising:
means for realizing the individual steps constructing of said management accounting method considering a time value according to claim 2.

13. A management accounting system comprising:
means for realizing the individual steps constructing of said management accounting method considering a time value according to claim 3.

14. A management accounting system comprising:
means for realizing the individual steps constructing of said management accounting method considering a time value according to claim 4.

15. A management accounting system comprising:
means for realizing the individual steps constructing of said management accounting method considering a time value according to claim 5.

16. A management accounting system comprising:
means for realizing the individual steps constructing of said management accounting method considering a time value according to claim 6.

17. A management accounting system comprising:
means for realizing the individual steps constructing of said management accounting method considering a time value according to claim 7.

18. A management accounting system comprising:
means for realizing the individual steps constructing of said management accounting method considering a time value according to claim 8.

19. A management accounting system comprising:
means for realizing the individual steps constructing of said management accounting method considering a time value according to claim 9.

20. A management accounting system comprising:
means for realizing the individual steps constructing of said management accounting method considering a time value according to claim 10.

21. A computer-readable recording medium recorded with programs for causing a computer to execute the individual steps constructing the management accounting method considering a time value according to claim 1.

22. A computer-readable recording medium recorded with programs for causing a computer to execute the individual steps constructing the management accounting method considering a time value according to claim 2.

23. A computer-readable recording medium recorded with programs for causing a computer to execute the individual steps constructing the management accounting method considering a time value according to claim 3.

24. A computer-readable recording medium recorded with programs for causing a computer to execute the individual steps constructing the management accounting method considering a time value according to claim 4.

25. A computer-readable recording medium recorded with programs for causing a computer to execute the individual steps constructing the management accounting method considering a time value according to claim 5.

26. A computer-readable recording medium recorded with programs for causing a computer to execute the individual steps constructing the management accounting method considering a time value according to claim 6.

27. A computer-readable recording medium recorded with programs for causing a computer to execute the individual steps constructing the management accounting method considering a time value according to claim 7.

28. A computer-readable recording medium recorded with programs for causing a computer to execute the individual steps constructing the management accounting method considering a time value according to claim 8.

29. A computer-readable recording medium recorded with programs for causing a computer to execute the individual steps constructing the management accounting method considering a time value according to claim 9.

30. A computer-readable recording medium recorded with programs for causing a computer to execute the individual steps constructing the management accounting method considering a time value according to claim 10.
